(19) United States
(12) Patent Application Publication
(10) Pub. No.: US 2022/0284414 A1
(43) Pub. Date: Sep. 8, 2022

(54) SYSTEM AND METHOD FOR MANAGING VALUE TRANSFER CARDS

(71) Applicant: The Toronto-Dominion Bank, Toronto (CA)

(72) Inventors: Davide IANNUZZI, North York (CA); Jeffrey MACDONALD, Ottawa (CA); Goran ILKANIZADEH, Ottawa (CA)

(73) Assignee: The Toronto-Dominion Bank, Toronto (CA)

(21) Appl. No.: 17/194,820

(22) Filed: Mar. 8, 2021

(51) Int. Cl. G06Q 20/34; G06Q 20/10; G06Q 20/20

(52) U.S. Cl. CPC G06Q 20/34; G06Q 20/1085; G06Q 20/20

(57) ABSTRACT

A processor-implemented method is disclosed. The method includes: detecting a transfer initiated using a value transfer card; obtaining subscription profile data of a subscription associated with the value transfer card, the subscription being associated with a transferor entity and a defined time period of validity; determining one or more enabled features of the value transfer card based on the subscription profile data of the subscription; and causing the transfer to be processed in accordance with transfer parameters that are associated with the one or more enabled features of the value transfer card.

### TECHNICAL FIELD

The present application relates to electronic data transfers and, more particularly, to systems and methods for processing transactions that are initiated using value transfer cards.

### BACKGROUND

Value transfer cards, such as credit or debit cards, may be used by customers for various types of transactions. For example, a value transfer card may enable the cardholder to make purchases at a point-of-sale (e.g., a merchant terminal) or access automatic teller machines (ATMs) for account-related transactions (e.g., deposits, money transfers, cash withdrawals, etc.). Transactions using value transfer cards are typically processed by computing systems that perform backend services relating to authentication, account access and management, and data transfer.

A typical value transfer card may be associated with a set of features or functionalities that are accessible to a user of the card. In particular, a fixed set of features may be defined for a value transfer card prior to the first use of the card. Customers may decide to use different value transfer cards for different purposes (e.g., online purchases, automated bill payments, etc.), depending on the predefined sets of features that are associated with the cards.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for processing an electronic transfer of value that is initiated using a value transfer card;

FIG. 4 shows, in flowchart form, an example method for processing a transaction that is initiated using a value transfer card;

FIG. 5 shows, in flowchart form, an example method for determining a processing action for a transaction based on a subscription associated with a value transfer card;

FIG. 6 shows, in flowchart form, an example method for providing recommendation of subscriptions to a transacting entity; and

FIG. 7 shows, in flowchart form, an example method for processing subscription modification events in connection with a subscription associated with a value transfer card.

Like reference numerals are used in the drawings to denote like elements and features.

### DETAILED DESCRIPTION OF VARIOUS EMBODIMENTS

In an aspect, a computing system is disclosed. The computing system includes a processor, a communications module coupled to the processor, and a memory coupled to the processor. The memory stores instructions that, when executed, configure the processor to: detect a transfer initiated using a value transfer card; obtain subscription profile data of a subscription associated with the value transfer card, the subscription being associated with a transferor entity and a defined time period of validity; determine one or more enabled features of the value transfer card based on the subscription profile data of the subscription; and cause the transfer to be processed in accordance with transfer parameters that are associated with the one or more enabled features of the value transfer card.

In some implementations, the one or more enabled features of the value transfer card may comprise a fee waiver condition associated with transfers of a first type using the value transfer card.

In some implementations, causing the transfer to be processed in accordance with the transfer parameters may include: determining that the transfer is a transfer of the first type; determining a first fee associated with transfers of the first type; and preventing a charge of the first fee in connection with a data record associated with the value transfer card.

In some implementations, obtaining the subscription profile data may include: determining a transfer initiation time associated with the transfer; and verifying that the subscription is active at the transfer initiation time.

In some implementations, the instructions, when executed, may further configure the processor to: detect a subscription modification event associated with the subscription; and update the subscription profile data for the subscription based on the detected subscription modification event.

In some implementations, the subscription modification event may comprise selectively disabling one or more enabled features of the value transfer card.

In some implementations, the subscription modification event may comprise deactivation of the subscription.

In some implementations, detecting the subscription modification event may include receiving, via an input interface, selection of a user interface element corresponding to a request to modify the subscription.

In some implementations, detecting the subscription modification event may include receiving, from a remote server, an indication that a modification has been made to the subscription.

In some implementations, the subscription profile data may indicate at least one of: a type associated with the subscription; a current subscription status; identities of one or more value transfer cards associated with the subscription; or currently enabled features associated with the one or more value transfer cards.

In another aspect, a computer-implemented method is disclosed. The method includes: detecting a transfer initiated using a value transfer card; obtaining subscription profile data of a subscription associated with the value transfer card, the subscription being associated with a transferor entity and a defined time period of validity; determining one or more enabled features of the value transfer card based on the subscription profile data of the subscription; and causing the transfer to be processed in accordance with transfer parameters that are associated with the one or more enabled features of the value transfer card.

In yet another aspect, a non-transitory computer readable storage medium is disclosed. The computer readable storage medium contains instructions thereon which, when executed by a processor, configure the processor to: detect a transfer initiated using a value transfer card; obtain subscription profile data of a subscription associated with the value transfer card, the subscription being associated with a transferor entity and a defined time period of validity; determine one or more enabled features of the value transfer card based on the subscription profile data of the subscription; and cause the transfer to be processed in accordance with transfer parameters that are associated with the one or more enabled features of the value transfer card.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

Value transfer cards, such as payment cards, can be used for making purchases at a point-of-sale or to access ATMs for account-related transactions. A value transfer card may be connected to one or more accounts (such as banking accounts) storing data and/or resources that are accessible to the cardholder. For example, a value transfer card may be associated with a primary, or default, account and a number of secondary accounts that can be used for specific transactions (e.g., foreign currency transactions). Any transaction that is initiated using a value transfer card may access resources of one of the accounts that are connected to the value transfer card.

A value transfer card may be associated with various card features. In some embodiments, the card features may define one or more card control settings. The card control settings may represent restrictions on transactions that are initiated using the value transfer card. By way of example, card control settings may define limits (e.g., credit limit, debit limit, etc.) on transaction amounts for transactions using the value transfer card. Any transaction that exceeds the relevant limit on transaction amount may be declined.

In some embodiments, the card features may define other settings relating to usage or ownership of the value transfer card. For example, the card features of a value transfer card may relate to services and benefits (e.g., rewards, discounts, low or no interest rates, etc.) that are accessible to cardholders, surcharges (e.g., foreign transaction fees) associated with certain types of transactions using the card, and fixed fees (e.g., annual fee, finance charge, late fee, over-the-limit fee, etc.) that are common to all holders of the same card type.

The card features of a value transfer card are typically imposed by a card issuer entity, such as a financial institution (e.g., bank) that issues the card to a customer. Customers may decide to use different value transfer cards for different purposes (e.g., online purchases, automated bill payments, etc.), depending on the predefined sets of card features that are associated with the cards. This can often be inefficient for customers as they may need to carry around multiple different cards and keep track of card features for the respective cards in order to decide on a suitable (or preferred) card to use for specific occasions. By having to carry multiple cards, customers may face increased risk of lost or stolen cards and greater possibility of using a non-optimal card for a particular transaction. With ever increasing range of feature offerings by card issuer entities, it is desirable to provide mechanisms for customers to access features of their value transfer cards in an efficient and secure manner.

Various technical solutions for managing value transfer cards are described in the present application. More specifically, systems and methods for processing transactions that are initiated using value transfer cards are disclosed. According to example embodiments, a value transfer card may be associated with at least one subscription that defines one or more card features of the value transfer card. In particular, subscription profile data for the subscription may define features of the value transfer card that are enabled or activated for the card. The transactions (e.g., value transfers) that are initiated using the value transfer card may be processed in accordance with transaction parameters associated with the enabled features of the value transfer card.

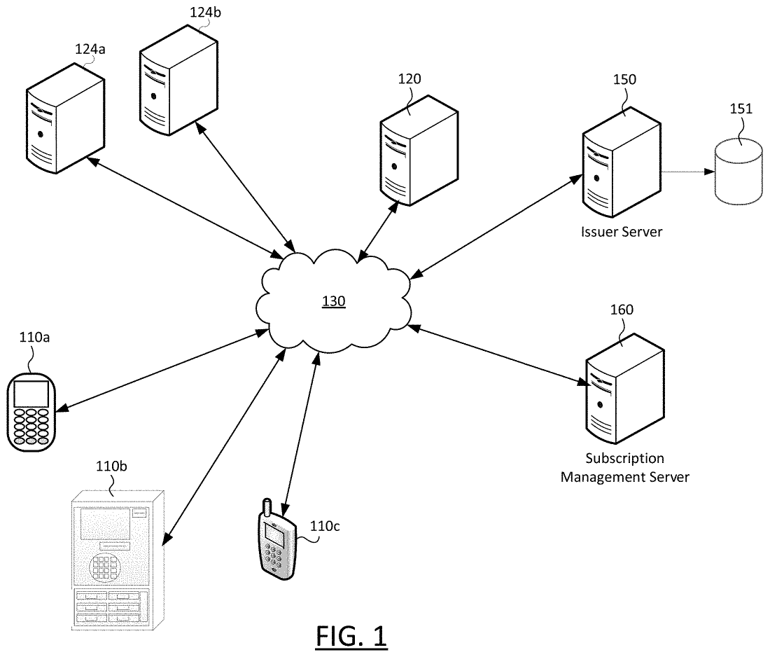

Reference is first made to FIG. 1, which is a schematic diagram illustrating an operating environment of an example embodiment.

As illustrated, a transfer rail server 120 communicates with a plurality of computing devices via a network 130. The remote computing devices may take a variety of forms. For example, as illustrated, the transfer rail server 120 may communicate with one or more point-of-sale (POS) terminals 110a, one or more automated teller machines (ATMs) 110b, and/or one or more other computing devices such as, for example, one or more transfer initiation systems 124a, 124b. The transfer initiation systems 124a, 124b may be or include, for example, electronic commerce (i.e., e-commerce) systems. An e-commerce system may be, for example, a server associated with an electronic commerce website such as an online store that sells or facilitates the sale of goods and/or services online. The transfer initiation systems 124a, 124b may, additionally or alternatively, include one or more computer systems that are not e-commerce servers. For example, the transfer initiation systems 124a, 124b may be or include utility or membership computing systems. For example, the transfer initiation systems may include computing devices associated with one or more of: telephone services, internet services, periodicals including magazines and newspapers, club memberships such as fitness memberships, utility services including, for example, water services, gas services, hydro services, etc.

The transfer rail server 120 may be a computing system that facilitates electronic funds transfer and may, in at least some embodiments, be referred to as a payment rail server. By way of example, the transfer rail server 120 may be a Visa™, Mastercard™, or American Express™ server. The transfer rail server 120 may be associated with a particular brand of value transfer cards. More particularly, the transfer rail server 120 may facilitate payment processing for a particular brand of value transfer cards, such as a particular brand of credit and/or charge card. By way of example, in some embodiments, the transfer rail server 120 may only process Visa transactions. The transfer rail server 120 may also, in at least some embodiments, be referred to as a credit card network server.

The transfer rail server 120 communicates with a computing system associated with card issuer entity, such as an issuer server 150. The issuer server 150 may be, for example, a computer system associated with a financial institution, such as a bank, that issued a value transfer card (e.g., credit, charge or debit card). Put differently, the issuer server 150 is associated with a value transfer card issuer. For example, the issuer server 150 may be operated, or managed, by an issuer entity for a value transfer card.

In at least some embodiments, the issuer server 150 may be a resource server. A resource server may track, manage, and maintain resources, make lending decisions, and/or lend resources to client entities. The resources may, for example, be computing resources, such as memory or processor cycles. In some embodiments, the resources may include stored value, such as fiat currency, which may be represented in a database. For example, the issuer server 150 may be coupled to a database 151 which may be provided in secure storage. The secure storage may be provided internally within the issuer server 150 or externally. The secure storage may, for example, be provided remotely from the issuer server 150, and may include one or more data centers. The data centers may, in some embodiments, store data with bank-grade security.

The database 151 may include data records for a plurality of accounts and at least some of the data records may define a quantity of resources associated with the client entity. For example, a client entity may be associated with an account having one or more data records in the database 151. The data records may reflect a quantity of stored resources that are associated with the client entity. Such resources may include owned resources and, in at least some embodiments, borrowed resources (e.g., resources available on credit). The quantity of resources that are available to or associated with the client entity may be reflected by a balance defined in an associated data record such as, for example, a bank balance.

A value transfer card may be or include a payment card (e.g., a credit card, a charge card, etc.). A value transfer card may have certain associated data. For example, a value transfer card may be associated with a primary account number (PAN), a verification number such as a credit card verification (CCV) number, and/or an expiry date. In at least some embodiments, a value transfer card may be associated with one or more data records of the database 151. The one or more data records may, for example, correspond to a banking account (e.g., credit card account, debit account, etc.) that is connected to the value transfer card. The value transfer card may be used for various account operations in connection with an account (and the associated data records). For example, a value transfer card may be used for initiating a transfer of value from a payment account associated with the cardholder.

A value transfer card may be used by the point-of-sale terminal 110 or another transfer initiation system 124a, 124b for processing a transfer of value from a cardholder to an entity associated with such systems. A value transfer card may also be used for transactions at an ATM 110b. For example, a value transfer card may be inserted into an ATM 110b to start a card session. Upon verification of the cardholder's identity, the cardholder may engage in various transactions (e.g., cash withdrawal, bill payments, check deposits, etc.) that are available to be performed at the ATM 110b.

In order to process a transfer of value using the value transfer card, a POS terminal or other transfer initiation system 124a, 124b may communicate with the transfer rail server 120. For example, the transfer initiation system 124a, 124b may send, to the transfer rail server 120, a transfer request. The transfer request may specify, for example, an amount of value associated with the request. The transfer request may also include or be associated with one or more credentials associated with a value transfer card. The credentials may include, for example, the PAN, expiry date, and/or verification number for the value transfer card. Other metadata may also be included in the transfer request such as, for example, an entity identifier such as a merchant identifier, location information specifying a location at which the transfer initiation system 124a, 124b purports to be located, and/or other information.

The credentials may take other forms. For example, the credentials may include a token. A token may be a non-decryptable piece of data that is used to represent, by reference, value transfer card data. Tokens may be issued by a tokenization service, which may be included in the transfer rail server 120 or provided by a separate system. The tokenization service and/or the transfer rail server 120 stores a mapping of a token to associated information such as, for example, value transfer card data. For example, the token may be mapped to one or more of an account number such as a PAN, a date (e.g., expiry date), verification data (e.g., CCV number), and/or a token holder. The token holder may identify an entity that the token was issued to and/or is associated with. The entity may, for example, be the transfer rail server 120. For example, the transfer rail server 120 may permit one or more third-party systems (e.g., the transfer initiation system 124a, 124b) to obtain and store a token for a particular value transfer card. The token is a representation of the value transfer card and may be stored by the transfer initiation system 124a, 124b for future use in issuing value transfer requests. The token may be unique to the entity to which it is issued. That is, different entities that receive tokens for the same value transfer card may receive different tokens, and the transfer rail server 120 and/or the tokenization service may track which entity received which token so that an entity that issued a value transfer request that includes a token may be identified.

After the transfer rail server 120 receives a value transfer request, it may communicate with an issuer server 150 to request approval of the value transfer request. The request for approval may include, for example, information included in or obtained from the value transfer request, such as the amount of the value transfer request. The request for approval may include information determined based on the token. For example, the PAN may be included in the request. The transfer rail server 120 receives a response to the request for approval (e.g., either an indication of approval or an indication of denial) and sends a corresponding message to the transfer initiation system 124a, 124b.

Accordingly, a transfer initiation system 124a, 124b may use a credential associated with a value transfer card in order to initiate a transfer. In some instances, the transfer initiation system 124a, 124b may store the credential for future use. For example, the value transfer initiation system 124a, 124b may store a representation of a value transfer card in a memory associated with the value transfer initiation system 124a, 124b. The representation of the value transfer card may either be a “card-on-file” representation of the value transfer card or a tokenized representation of the value transfer card. In the card-on-file representation, the value transfer initiation system 124a, 124b stores the PAN, expiry date and, in some instances, the verification information associated with the value transfer card. In the tokenized representation, the value transfer initiation system 124a, 124b stores a token of the type referred to above.

As cardholders use their value transfer card with various third-party entities, representations of the value transfer card may be stored at numerous locations. While two transfer initiation systems 124a, 124b are illustrated in FIG. 1, the number of transfer initiation systems 124a, 124b having a stored representation of the value transfer card may be much greater.

The issuer server 150 may communicate with a client device 110c via the network 130 in order to allow the client device 110c to be used in managing a value transfer card. In particular, the issuer server 150 and the client device 110c may cooperate to provide a card management user interface on an output device, such as a display, of the client device 110c. A cardholder may interact with a card management user interface in order to input instructions to the client device 110c. For example, at least some such instructions may cause the client device 110c to send a management request or command to the issuer server 150.

The management request or command may take various forms. As an example, in some instances, the management request or command may be an instruction to apply one or more card control settings to selected accounts. Card control settings for a value transfer card are controls (or restrictions) that are imposed on transactions which may be initiated using the value transfer card. The card controls may be applied in real-time on a per-account and/or per-card basis when processing transaction requests associated with the value transfer card.

As another example, the management request/command may be an instruction to enable or disable select card features for a value transfer card. The card management user interface may display, for example, one or more user interface elements corresponding to select card features which may be enabled or disabled by the cardholder. A cardholder may indicate their preference of features to enable for a value transfer card (for example, by inputting selection of one or more of the user interface elements) and the selections may be transmitted to the issuer server 150. The enabled card features may be applied by the issuer server 150 when processing transactions that are initiated using the value transfer card subsequent to the selection of the card features. As will be described in greater detail below, the enabling or disabling of card features for a value transfer card may be performed in bulk by processing subscription profile data associated with the value transfer card.

The client device 110c may include stored representations of one or more value transfer cards. For example, a token associated with a value transfer card may be stored in secure memory of the client device 110c to allow the client device 110c to be used for initiating transactions, i.e., value transfers. For example, the client device 110c may include a near field communication (NFC) subsystem which may be used to send a token to the POS terminal 110a in order to initiate or complete a transaction.

The client device 110c may take a variety of forms including, for example, a mobile communication device such as a smartphone, a tablet computer, a wearable computer such as a head-mounted display or smartwatch, a laptop or desktop computer, or a computing device of another type. The client device 110c is associated with a client entity (e.g., an individual, an organization, etc.) having resources that are managed by or via a resource server. In some embodiments, the issuer server 150 may be such resource server. For example, the issuer server 150 may be a financial institution server and the client entity may be a customer of a financial institution operating the financial institution server. The client device 110c may store software instructions that cause the client device to establish communications with the issuer server 150.

FIG. 1 also illustrates a subscription management server 160. As used in the present disclosure, the term “subscription” refers to a business model in which a customer pays a recurring price at regular defined intervals for access to certain products or services. A subscription management server 160 administers subscriptions for one or more customers. In the specific context of value transfer cards, a subscription may allow subscribing cardholders to access certain defined sets of card features. That is, a cardholder with a subscription may have access to certain card features (e.g., cashback, redeemable points, fee waivers, etc.) that are not available to non-subscribers. The terms “subscription” and “subscription plan” are used herein interchangeably to refer to data describing billing strategies for subscriptions. A subscription plan may indicate, for example, item(s) being subscribed to, price, and billing interval.

Subscriptions for value transfer cards may be predefined or they may be customized for individual subscribers. A card issuer entity may offer one or more predefined subscriptions when a customer registers for a value transfer card. The predefined subscriptions may be associated with a fixed set of card features that can be enabled for the value transfer card. Alternatively, a customizable subscription may allow cardholders to select a set of card features that are desired to be enabled upon subscribing to the plan. For example, a subscriber may select, from a set of available card features, a subset of features that are to be enabled for their value transfer card.

A subscription may be associated with one or more resource accounts. In particular, a subscription that is associated with a resource account may define card features for a value transfer card that is connected to the resource account. For example, a subscription for a resource account may indicate the card features associated with payment cards (e.g., credit, charge or debit card) that are associated with the resource account. That is, a subscription may be associated with one or more cards that are connected to the same account. Additionally, or alternatively, a subscription may be associated with a specific value transfer card. Such card-specific subscriptions may indicate the card features of a single card.

The subscription management server 160 may store subscription information for a plurality of cardholders and/or account owners. In at least some embodiments, the subscription management server 160 may perform various operations relating to management of subscriptions for value transfer cards including, but not limited to: administering registration of subscriptions; modifying or cancelling registration plans; updating subscriber information for subscriptions; adding one or more cards to existing subscriptions; processing requests to obtain subscription profile data; and payments (e.g., subscription fee payments) processing in connection with subscriptions.

FIG. 1 illustrates the issuer server 150 and the subscription management server 160 as different computing systems. In some embodiments, the management functions of the subscription management server 160 may be performed, in whole or in part, by the issuer server 150. In particular, the issuer server 150 may administer subscriptions that are associated with value transfer cards provided (e.g., issued) by the issuer server 150. More generally, the management functions of the subscription management server 160 may be implemented by a computing system, such as a server computer, or as a component (e.g., module) that is integrated in a computing system.

The point-of-sale terminal 110a, ATM 110b, client device 110c, transfer initiation systems 124a, 124b, issuer server 150, subscription management server 160, and the transfer rail server 120 may be in geographically disparate locations. Put differently, each of the point-of-sale terminal 110a, ATM 110b, client device 110c, transfer initiation systems 124a, 124b, issuer server 150, subscription management server 160, and the transfer rail server 120 may be remote from others of the point-of-sale terminal 110a, ATM 110b, client device 110c, transfer initiation systems 124a, 124b, issuer server 150, subscription management server 160, and the transfer rail server 120.

As described above, the point-of-sale terminal 110a, ATM 110b, client device 110c, transfer initiation systems 124a, 124b, issuer server 150, subscription management server 160, and the transfer rail server 120 may each be a computer system and/or a computing device.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, or the like. Additionally, or alternatively, the network 130 may be or may include one or more payment networks. The network 130 may, in some embodiments, include a plurality of distinct networks. For example, communications between certain of the computer systems may be over a private network whereas communications between other of the computer systems may be over a public network, such as the Internet.

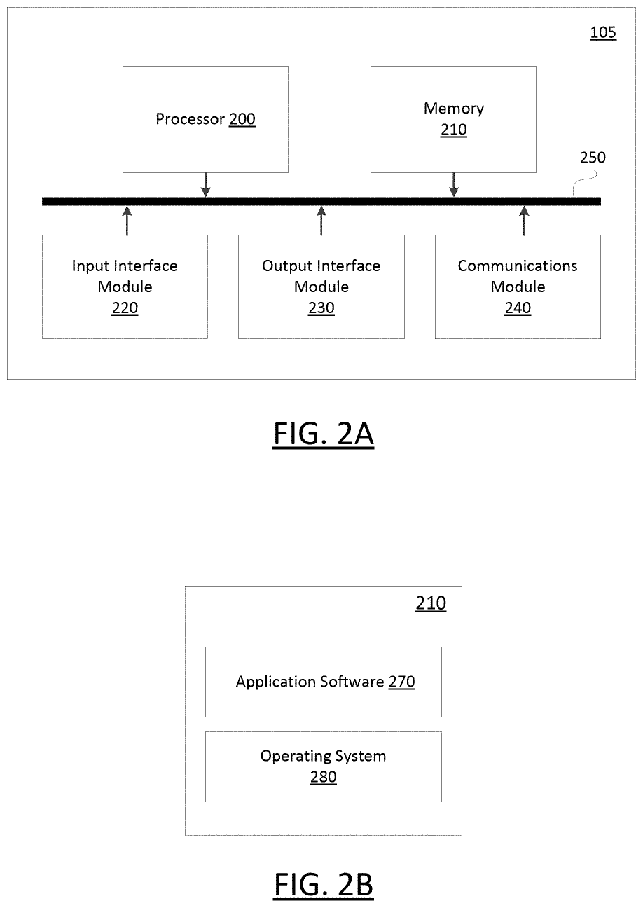

FIG. 2A is a high-level operation diagram of an example computing device 105. In some embodiments, the example computing device 105 may be exemplary of one or more of the point-of-sale terminal 110a, ATM 110b, client device 110c, transfer initiation systems 124a, 124b, issuer server 150, subscription management server 160, and the transfer rail server 120. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google™ Android™, Linux™, Microsoft™ Windows™, or the like.

The application software 270 adapts the example computing device 105, in combination with the operating system 280, to operate as a device performing particular functions. The application software 270 may, for example, include a resource account management application. In some example implementations, a resource account management application may allow users to control various features of their resource accounts. In particular, the resource account management application may provide a functionality for managing card features of one or more value transfer cards that are associated with resource accounts.

The application software 270 adapts the example computing device 105, in combination with the operating system 280, to operate as a device performing a particular function. For example, the application software 270 may cooperate with the operating system 280 to adapt a suitable embodiment of the example computing device 105 to operate as the point-of-sale terminal 110a, ATM 110b, client device 110c, transfer initiation systems 124a, 124b, issuer server 150, subscription management server 160, and the transfer rail server 120.

While a single application software 270 is illustrated in FIG. 2B, in operation, the memory 210 may include more than one application software 270 and different application software 270 may perform different operations.

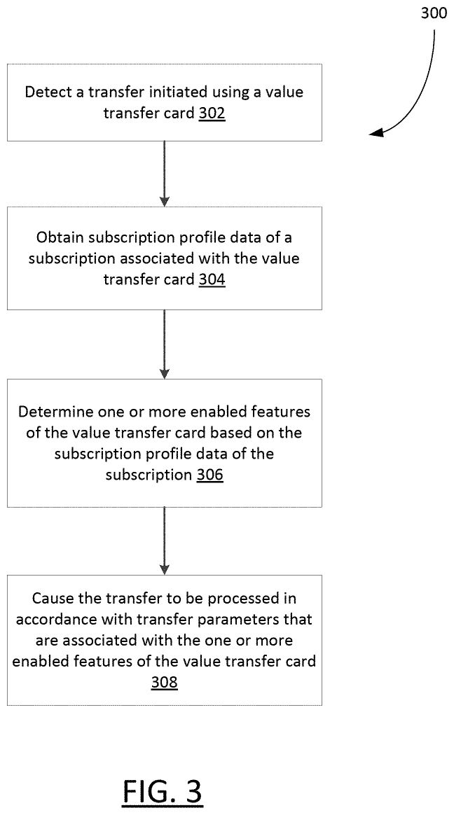

Reference is now made to FIG. 3 which shows, in flowchart form, an example method 300 for processing an electronic transfer of value that is initiated using a value transfer card. The method 300 may be implemented by a computing system associated with a card issuer entity, such as the issuer server 150 of FIG. 1. An issuer computing system may implement the operations of method 300 in conjunction with one or more of: a subscription management server; a client device; acquiring merchant (or acquiring) institution servers; one or more transfer initiation systems; and payment rail server. Operations 302 and onward may be performed by one or more processors of a computing device such as, for example, the processor 200 (FIG. 2A) of suitably configured instances of the example computing device 105 (FIG. 2A).

In operation 302, the issuer computing system detects an electronic transfer that is initiated using a value transfer card. The electronic transfer may, for example, be a transfer of value associated with a transaction, such as a purchase transaction. In some embodiments, the issuer computing system may detect a transaction that is initiated at a terminal device using the value transfer card. The terminal device may, for example, be a POS terminal or an ATM. The issuer computing system may detect a transaction when a transaction request is received by the issuer computing system. The transaction request may, for example, be a request to process a purchase transaction at a merchant's POS or an ATM action. In some embodiments, the issuer computing system may detect a transfer, or transaction, that is associated with a transfer initiation system, such as an e-commerce website (e.g., a merchant's online store) or a utility supplier. The detected transfer may correspond to, for example, a payment transfer from a specific payor account to an acquiring account, such as a merchant's or service provider's banking account. More generally, a transfer may be detected when a transaction processing request is received at the issuer computing system, for example, via a payment rail server.

In operation 304, the issuer computing system obtains subscription profile data of a subscription associated with the value transfer card. A subscription is associated with a specific transferor (or transacting) entity and a defined time period of validity (i.e., subscription period). The issuer computing system may obtain the subscription profile data from a third-party source (e.g., subscription management server). Alternatively, the issuer computing system may maintain a data store containing subscription information for a plurality of subscriptions. In particular, the issuer computing system may maintain a data store of subscriptions for value transfer cards that are issued by the issuer computing system. The issuer computing system may access the data store and retrieve subscription profile data in connection with a specific subscription.

In some embodiments, a subscription profile may be defined for a value transfer card. That is, a subscription profile may be associated with a specific card. The features (e.g., rewards) of the subscription that are available to subscribers may be card-specific, i.e., accessible by virtue of usage or ownership of the card. In some embodiments, a subscription profile may be defined for a resource account. That is, a subscription profile may apply to one or more value transfer cards that are connected to a specific resource account. The features of the subscription that are available to subscribers may be resource-specific, i.e., accessible by virtue of usage or ownership of cards associated with the account. In some embodiments, a subscription profile may be defined for a particular customer. That is, a subscription profile may apply to one or more resource accounts of a customer and value transfer cards that are connected to those resource accounts. The features of the subscription that are available to subscribers may be customer-specific, i.e., accessible by the customer only.

The subscription profile data may include various information about a subscription that relates to at least one of: a customer account, a resource account, or a value transfer card. In particular, the subscription profile data may indicate one or more of the following: a type associated with the subscription; a current subscription status of the subscription; identifying information for one or more value transfer cards that are associated with the subscription; and currently enabled features for the one or more value transfer cards.

In operation 306, the issuer computing system determines one or more enabled features of the value transfer card based on the subscription profile data of the subscription. The enabled features are features that are indicated by the subscription profile data as being available to a subscriber entity. In particular, the enabled features refer to access-limited features that a subscriber entity may access through usage or ownership of the value transfer card. For example, an enabled feature of a value transfer card may comprise a fee waiver condition associated with transfers of a specific type (e.g., foreign currency transactions) that are initiated using the value transfer card. Various card features, such as rewards, fee waivers, lower interest rates, etc., may be “enabled” or “activated” by the subscriber. For example, a cardholder may select card features that are desired to be included in and enabled for a subscription that is associated with a value transfer card.

The subscription profile data may indicate those features of the value transfer card that are currently enabled, as well as features that were previously enabled and/or features that are not enabled (e.g., not included in the subscription, or available but not activated by cardholder). The issuer computing system may continuously monitor the subscription profile data to maintain an up-to-date list of card features that are enabled for the value transfer card.

In operation 308, the issuer computing system causes the transfer to be processed in accordance with transfer parameters that are associated with the one or more enabled features of the value transfer card. In particular, the issuer computing system determines the card features that are currently enabled for the value transfer card and determines how to process the requested transfer/transaction based on the enabled features. By way of example, the issuer computing system may first determine a type associated with the transfer. The transfer may, for example, be a foreign transaction (e.g., a purchase that passes through a foreign bank or is in a foreign currency). The issuer computing system may then determine any fees (e.g., foreign transaction fee) that are associated with transfers of the determined type. Upon verifying that a corresponding fee waiver condition is defined by the subscription profile associated with the value transfer card, the issuer computing system may prevent a charge of the fee in connection with an account (i.e., data record) associated with the value transfer card. As another example, the issuer computing system may determine that the transfer is associated with a reward (e.g., cashback, loyalty points) accrual feature defined by the subscription profile data for the value transfer card. The issuer computing system may first determine the reward information (e.g., type of reward, quantum of reward, etc.) for the reward(s) associated with the transfer, and the transfer may be processed by taking actions that are necessary for providing the cardholder with the reward(s).

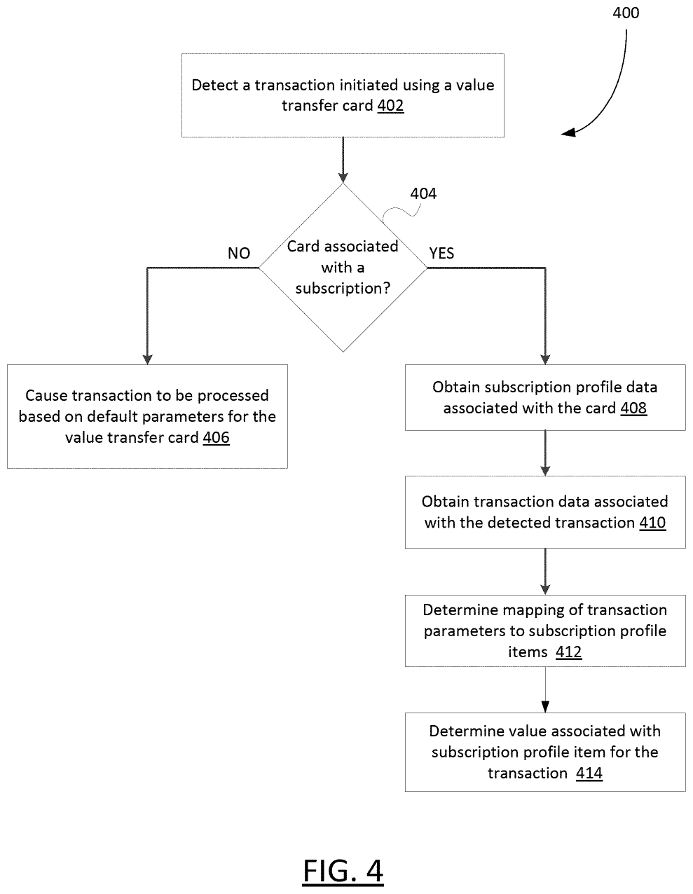

Reference is now made to FIG. 4 which shows, in flowchart form, an example method 400 for processing a transaction that is initiated using a value transfer card. The method 400 may be implemented by a computing system associated with a card issuer entity, such as the issuer server 150 of FIG. 1. An issuer computing system may implement the operations of method 400 in conjunction with one or more of: a subscription management server; a client device; acquiring merchant (or acquiring) institution servers; one or more transfer initiation systems; and payment rail server. Operations 402 and onward may be performed by one or more processors of a computing device such as, for example, the processor 200 (FIG. 2A) of suitably configured instances of the example computing device 105 (FIG. 2A). The operations of method 400 may be performed in addition to, or as alternatives of, one or more of the operations of method 300.

In operation 402, the issuer computing system detects a transaction that is initiated using a value transfer card. The transaction may be detected in a similar manner as described above with respect to operation 302 of method 300.

In operation 404, the issuer computing system determines whether the value transfer card is associated with a subscription. For example, the issuer computing system may determine whether a subscription profile is defined for the value transfer card, a resource account connected to the value transfer card, or a particular customer (e.g., cardholder or account owner) that is associated with the value transfer card. In some embodiments, the issuer computing system may query a subscription management service (e.g., a service administered by a subscription managements server) using identifying information for the value transfer card to ascertain whether the card is associated with a subscription.

If the value transfer card is determined to not be associated with a subscription, the issuer computing system causes the transaction to be processed based on a set of default parameters for the value transfer card, in operation 406. A default set of transaction parameters may be defined for a value transfer card such that, in the absence of additional features which may be enabled in connection with the value transfer card, any transaction that is initiated using the value transfer card may be processed in accordance with the default parameters. The default transaction parameters for a value transfer card may, for example, be defined by an issuer entity for the card and stored in a data store that is accessible by the issuer computing system.

If, on the other hand, the issuer computing system determines that the value transfer card is associated with at least one subscription, the method proceeds to operation 408. The issuer computing system obtains subscription profile data associated with the value transfer card in operation 408, and obtains transaction data associated with the detected transaction in operation 410. The transaction data may indicate various transaction parameters such as transaction (e.g., purchase, payment, etc.) amount, identifier of a merchant or service provider, time of the transaction, any related transaction processing fees, and applicable tax(es) for the transaction.

In operation 412, the issuer computing system determines a mapping of transaction parameters to subscription profile items of the subscription. More specifically, the issuer computing system determines features that are defined by a subscription profile for a value transfer card, and determines a mapping that associates those features with transaction parameters as indicated by the transaction data for the detected transaction. By way of example, the subscription profile of a subscription for a value transfer card may indicate a fee waiver or fee discount condition that is applicable to transactions that are initiated using the value transfer card. The issuer computing system may determine a mapping that associates the fee waiver/discount condition (a subscription profile item) with the related transaction parameter (e.g., transaction fee(s)) for the detected transaction. Such a mapping allows for identifying those transaction parameters of a transaction which are to be varied (e.g., modified or updated) as a result of the enabled features of the subscription that is associated with the value transfer card used to initiate the transaction.

The issuer computing system then determines a value of each of one or more subscription profile items for the transaction, in operation 414. The value may, for example, be a numerical value (e.g., a percentage discount, a fee reduction, etc.) in connection with a subscription profile item, such as a fee waiver or discount condition. Alternatively, the value may be a binary value (e.g., yes or no) in connection with a subscription profile item, such as a “collect rewards” condition. Once the value for each of the subscription profile items are determined, the issuer computing system may cause the transaction to be processed in accordance with a modified set of transaction parameters. More specifically, the transaction may be processed based on the transaction parameters that are varied as a result of the enabled features of the subscription for the value transfer card. In particular, the transaction parameters may be varied from a default set of parameters defined for the value transfer card such that the modified parameters are different from the default set in at least one parameter.

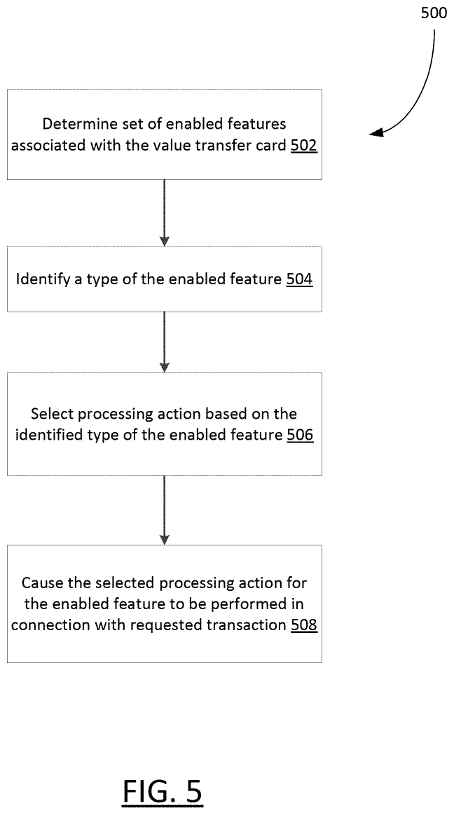

Reference is now made to FIG. 5 which shows, in flowchart form, an example method 500 for determining a processing action for a transaction based on a subscription associated with a value transfer card. The method 500 may be implemented by a computing system associated with a card issuer entity, such as the issuer server 150 of FIG. 1. An issuer computing system may implement the operations of method 500 in conjunction with one or more of: a subscription management server; a client device; acquiring merchant (or acquiring) institution servers; one or more transfer initiation systems; and payment rail server. Operations 502 and onward may be performed by one or more processors of a computing device such as, for example, the processor 200 (FIG. 2A) of suitably configured instances of the example computing device 105 (FIG. 2A). The operations of method 500 may be performed in addition to, or as alternatives of, one or more of the operations of methods 300 and 400.

In operation 502, the issuer computing system determines a set of enabled features that are associated with a value transfer card. In at least some embodiments, the enabled features may be defined in subscription profile data of a subscription that is associated with the value transfer card. The issuer computing system may obtain subscription profile data (e.g., by retrieving from an internal data store or from a remote subscription management server) and determine, based on the subscription profile data, a set of access-limited features that are available for the value transfer card.

For each of the enabled features, the issuer computing system identifies a type of the feature, in operation 504. For example, the enabled features may be categorized as one or more of the following types: a fee waiver, a fee discount, a points reward, cashback, sign-up bonus, interest waiver, interest discount, etc. The set of categories, or types, for card features may be updated dynamically by the issuer computing system.

In operation 506, the issuer computing system selects a processing action for the enabled feature based on the identified type of the feature. In at least some embodiments, the issuer computing system may determine a mapping of card features to processing actions. For example, the mapping may associate a fee waiver feature/condition with an action for preventing or eliminating a charge of the relevant fee on transactions that are initiated using the value transfer card. As another example, a fee discount may be associated with an action for charging a reduced fee on transactions that are initiated using the value transfer card. As yet another example, a reward condition (e.g., cashback, loyalty program points, etc.) may be associated with one or more actions that are necessary for providing, to the cardholder, rewards in connection with transactions that are initiated using the value transfer card.

In operation 508, the issuer computing system causes the selected processing action for the enabled feature to be performed in connection with the requested transaction. In particular, the issuer computing system may determine the set of all card features that are enabled by virtue of the subscription profile associated with the value transfer card, and cause a set of actions corresponding to the enabled card features to be performed as part of the transaction processing for transactions initiated using the value transfer card.

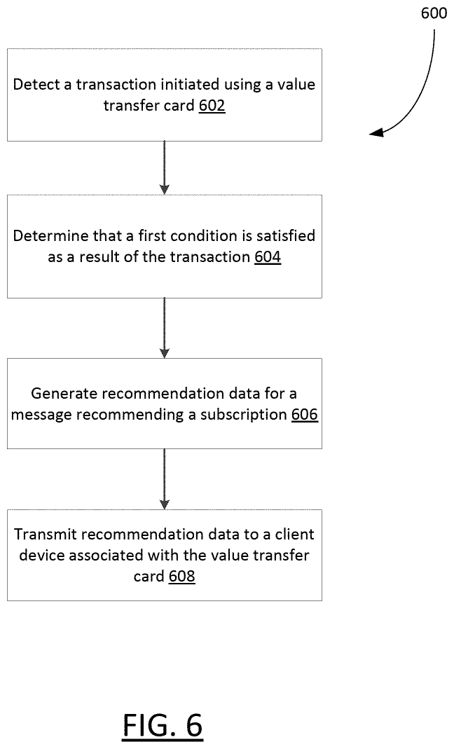

Reference is now made to FIG. 6 which shows, in flowchart form, an example method 600 for providing recommendation of subscriptions to a transacting entity. The method 600 may be implemented by a computing system associated with a card issuer entity, such as the issuer server 150 of FIG. 1. An issuer computing system may implement the operations of method 600 in conjunction with one or more of: a subscription management server; a client device; acquiring merchant (or acquiring) institution servers; one or more transfer initiation systems; and payment rail server. Operations 602 and onward may be performed by one or more processors of a computing device such as, for example, the processor 200 (FIG. 2A) of suitably configured instances of the example computing device 105 (FIG. 2A). The operations of method 600 may be performed in addition to, or as alternatives of, one or more of the operations of methods 300, 400 and 500.

In certain instances, it may be desirable for a cardholder to subscribe to a subscription that offers certain benefits which may be relevant for the cardholder. In particular, if a cardholder frequently conducts transactions of a defined type (e.g., foreign transactions, automated bill payments, etc.), it may be desirable for the cardholder to subscribe to a subscription that includes card features representing benefits that accrue in connection with transactions of said type. The issuer computing system may be configured to generate recommendations for cardholders in connection with relevant subscription for their value transfer cards.

In operation 602, the issuer computing system detects a transaction that is initiated using a value transfer card. The transaction may be detected in a similar manner as described above with respect to operation 302 of method 300.

In operation 604, the issuer computing system determines that a first condition is satisfied as a result of the transaction. The first condition represents a condition that facilitates determination of whether a subscription should be recommended to a particular customer (e.g., cardholder). The first condition may, for example, relate to a number or frequency of transactions of a defined type that are conducted by the customer/cardholder. For example, the first condition may be associated with a defined threshold number/frequency. If the first condition is satisfied as a result of the detected transaction (i.e., a threshold number/frequency of transactions of a first type is exceeded), the issuer computing system may determine that a suitable recommendation of subscription options should be provided to the customer in connection with their value transfer card.

In operation 606, the issuer computing system generates recommendation data to include in a message for recommending a subscription to a customer. In particular, the recommendation data is generated for a customer (e.g., cardholder, account owner, etc.) that is associated with the value transfer card. The recommendation data may indicate, for example, the condition(s) that are detected in connection with the value transfer card and one or more suitable options for subscriptions that the customer may be interested in. The recommendations for subscriptions may be determined, for example, by filtering a set of all available subscriptions that can be offered by the issuer computing system to identify those subscriptions offering one or more rewards in connection with transactions that are initiated using the value transfer card. For example, the recommended subscriptions may be subscriptions offering card features that are not currently associated with transactions conducted by the customer using the value transfer card.

In operation 608, the issuer computing system transmits the recommendation data to a client device associated with the value transfer card. The recommendation data may be provided in a message, such as an email, or as a notification (e.g., push notification) in an application resident on a client device that is used for managing resource accounts and/or value transfer cards.

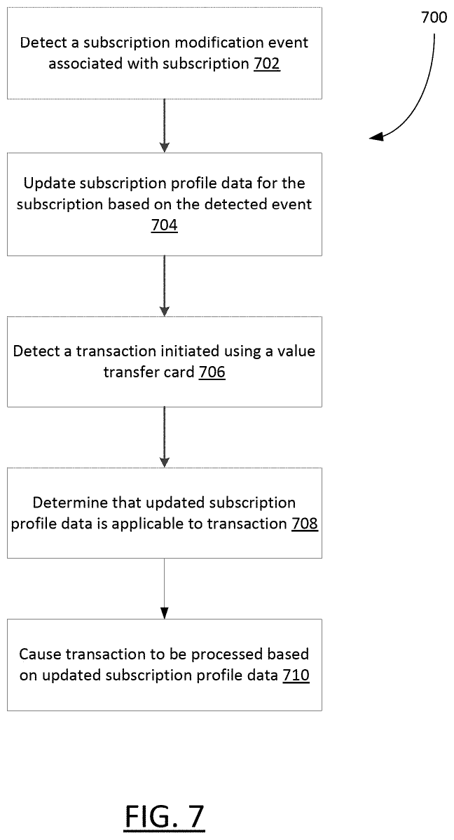

Reference is now made to FIG. 7 which shows, in flowchart form, an example method 700 for processing subscription modification events in connection with a subscription associated with a value transfer card. The method 700 may be implemented by a computing system associated with a card issuer entity, such as the issuer server 150 of FIG. 1. An issuer computing system may implement the operations of method 700 in conjunction with one or more of: a subscription management server; a client device; acquiring merchant (or acquiring) institution servers; one or more transfer initiation systems; and payment rail server. Operations 702 and onward may be performed by one or more processors of a computing device such as, for example, the processor 200 (FIG. 2A) of suitably configured instances of the example computing device 105 (FIG. 2A). The operations of method 700 may be performed in addition to, or as alternatives of, one or more of the operations of methods 300, 400, 500 and 600.

In operation 702, the issuer computing system detects a subscription modification event associated with a subscription. A subscription may be modified, for example, by varying one or more features of the subscription. For example, a subscription modification event may be a selective disabling of one or more enabled card features of a value transfer card associated with the subscription. A subscription may also be modified by changing the subscription plan altogether (e.g., changing billing interval, upgrading to a different subscription, etc.). For example, a subscription modification event may be a deactivation of an active subscription.

In some embodiments, the issuer computing system may detect a subscription modification event upon receiving, via an input interface associated with a client device, user input representing a request to modify the subscription. For example, a user may input, via a graphical user interface that allows for managing card subscriptions, selection of a user interface element (e.g., toggle button) that corresponds to activation or deactivation of a subscription. Additionally, or alternatively, the issuer computing system may detect a subscription modification event if a remote computing system, such as a computer server, provides an indication to the issuer computing system that a modification has been made to the subscription. The remote computing system may be, for example, a server administering subscriptions associated with value transfer cards (such as subscription management server 160 of FIG. 1). If the subscription management server determines that a change is made to a subscription (e.g., failure to renew or pay for subscription, manual cancellation of subscription, etc.), the server may transmit, to the issuer computing system, a message indicating the specific change to the subscription.

In operation 704, the issuer computing system updates subscription profile data for the subscription based on the detected subscription modification event. In at least some embodiments, the issuer computing system may update a data store containing subscription profile information for a plurality of subscriptions to indicate the modification to a specific subscription.

In operation 706, the issuer computing system detects a transaction that is initiated using a value transfer card. That is, a transaction using the value transfer card is detected after the subscription modification event for the subscription associated with the value transfer card. In operation 708, the issuer computing system determines that updated subscription profile data is applicable to the detected transaction. For example, the issuer computing system may determine a time associated with the transaction (e.g., payment transfer initiation time), and compare this time to a change of the detected subscription modification event. Based on the comparison, the issuer computing system may determine that the updated subscription profile data should be used for processing the transaction. In particular, the updated subscription profile may be applicable to the transaction if the subscription modification event occurred prior to the transaction.

In operation 710, the issuer computing system causes the transaction to be processed based on the updated subscription profile data. That is, the transaction is processed based on the features that are enabled for the value transfer card subsequent to the subscription modification event.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing instructions that, when executed, configure the processor to:
provide, via a client device, a card management interface for managing control settings of value transfer cards that are associated with a resource account, the card management interface including user interface elements for selectively enabling card features;
receive, via the card management interface, user input representing a request to modify a subscription associated with a first value transfer card, the subscription being associated with a transferor entity and a defined time period of validity;
modify subscription profile data of the subscription based on the request;
detect a first card transaction that is initiated at one of a point-of-sale or an automatic teller machine using the first value transfer card;
obtain updated subscription profile data of-the subscription;
determine one or more enabled features of the first value transfer card based on the updated subscription profile data of the subscription;
identify transaction parameters of the first transaction to vary based on the one or more enabled features of the first value transfer card, the identifying including obtaining transaction data associated with the detected card transaction and determining a mapping of transaction parameters to subscription profile items of the updated subscription; and
cause the first card transaction to be processed by performing an account operation for the resource account in accordance with varied transaction parameters that are associated with the one or more enabled features of the first value transfer card.

2. The computing system of claim 1, wherein the one or more enabled features of the first value transfer card comprise a fee waiver condition associated with transfers of a first type using the first value transfer card.

3. The computing system of claim 2, wherein causing the transfer to be processed comprises:
determining that the first card transaction is a transfer of the first type;
determining a first fee associated with transfers of the first type; and
preventing a charge of the first fee in connection with a data record associated with the resource account.

4. The computing system of claim 1, wherein obtaining the updated subscription profile data comprises:
determining a transfer initiation time associated with the first card transaction; and
verifying that the subscription is active at the transfer initiation time.

5. The computing system of claim 1, wherein the instructions, when executed, further configure the processor to:
detect a subscription modification event associated with the subscription; and
update the subscription profile data for the subscription based on the detected subscription modification event.

6. The computing system of claim 5, wherein the subscription modification event comprises selectively disabling one or more enabled features of the first value transfer card.

7. The computing system of claim 5, wherein the subscription modification event comprises deactivation of the subscription.

8. (canceled)

9. The computing system of claim 5, wherein detecting the subscription modification event comprises receiving, from a remote server, an indication that a modification has been made to the subscription.

10. The computing system of claim 1, wherein the subscription profile data indicates at least one of:
a type associated with the subscription;
a current subscription status;
identities of one or more first value transfer cards associated with the subscription; or
currently enabled features associated with the one or more first value transfer cards.

11. A computer-implemented method, comprising:
providing, via a client device, a card management interface for managing control settings of value transfer cards that are associated with a resource account, the card management interface including user interface elements for selectively enabling card features;
receiving, via the card management interface, user input representing a request to modify a subscription associated with a first value transfer card, the subscription being associated with a transferor entity and a defined time period of validity;
modifying subscription profile data of the subscription based on the request;
detecting a first card transaction that is initiated at one of a point-of-sale or an automated teller machine using the value card;
obtaining updated subscription profile data of the subscription;
determining one or more enabled features of the first value transfer card based on the updated subscription profile data of the subscription;
identifying transaction parameters of the first card transaction to vary based on the one or more enabled features of the first value card, the identifying including obtaining transaction data associated with the detected card transaction and determining a mapping of transaction parameters to subscription profile items of the updated subscription; and
causing the first card transaction to be processed by performing an account operation for the resource account in accordance with varied transaction parameters that are associated with the one or more enabled features of the first value card.

12. The method of claim 11, wherein the one or more enabled features of the first value transfer card comprise a fee waiver condition associated with transfers of a first type using the first value transfer card.

13. The method of claim 12, wherein causing the transfer to be processed comprises:
determining that the first card transaction is a transfer of the first type;
determining a first fee associated with transfers of the first type; and
preventing a charge of the first fee in connection with a data record associated with the resource account.

14. The method of claim 11, wherein obtaining the updated subscription profile data comprises:
determining a transfer initiation time associated with the first card transaction; and
verifying that the subscription is active at the transfer initiation time.

15. The method of claim 11, further comprising:
detecting a subscription modification event associated with the subscription; and
updating the subscription profile data for the subscription based on the detected subscription modification event.

16. The method of claim 15, wherein the subscription modification event comprises selectively disabling one or more enabled features of the first value transfer card.

17. The method of claim 15, wherein the subscription modification event comprises deactivation of the subscription.

18. (canceled)

19. The method of claim 15, wherein detecting the subscription modification event comprises receiving, from a remote server, an indication that a modification has been made to the subscription.

20. The method of claim 11, wherein the subscription profile data indicates at least one of:
a type associated with the subscription;
a current subscription status;
identities of one or more first value transfer cards associated with the subscription; or
currently enabled features associated with the one or more first value transfer cards.
